(19) United States
(12) Patent Application Publication
(10) Pub. No.: US 2005/0000743 A1
(43) Pub. Date: Jan. 6, 2005

(54) Herschel-Quincke tube arrangements for motor vehicles

(76) Inventors: Paul Desmond Daly, Troy, MI (US); Roy Haworth, Shrewsbury (GB); Ian R. McLean, Chatham (CA); James Kenneth Vanderveen, Blenheim (CA); Zhouxuan Xia, Windsor (CA)

Correspondence Address: Elsa Keller;Siemens Corporation, Intellectual Property Department, 170 Wood Avenue South, Iselin, NJ, 08830, US

(21) Appl. No.: 10/664,751

(22) Filed: Sep. 18, 2003

Related U.S. Application Data
(63) Continuation-in-part of application No. 10/624,629, filed on Jul. 22, 2003.
(60) Provisional application No. 60/418,658, filed on Oct. 15, 2002.
(60) Provisional application No. 60/409,205, filed on Sep. 9, 2002.
(60) Provisional application No. 60/401,161, filed on Aug. 5, 2002.
(60) Provisional application No. 60/397,708, filed on Jul. 22, 2002.

(51) Int. Cl. B60K 11/00

(52) U.S. Cl. 180/68.1; 123/198 E

(57) ABSTRACT

An HQ tube arrangement suitable for packaging within a vehicle includes a first passageway having a fluid inlet and a fluid outlet and a second passageway located adjacent the first passageway. The second passageway is fluidly connected to the first passageway at first and second spaced apart junctions with the second passageway being divided by the junctions into first, second and third passages. The second passageway includes first and second opposing terminal ends respectively spaced from the first and second junctions wherein portions of the first, second and third passageways are oriented in a substantially similar direction to that of the first passageway to form a substantially rectangular configuration.

### CROSS REFERENCE TO RELATED APPLICATIONS AND PRIORITY CLAIMS

This application claims the benefit of U.S. Provisional Application No. 60/418,658 (Attorney Docket No. 2002P16918US) filed on Oct. 15, 2002 in the name of Paul Daly, Ian R. Mclean, Roy Haworth and Zhouxuan Xia and entitled QUINCKE TUBE ARRANGEMENTS FOR AUTOMOTIVE 4 CYLINDER INDUCTION SYSTEM NOISE ATTENTUATION which is hereby incorporated by reference herein in its entirety. This application is also a continuation in part of U.S. Ser. No. 10/624,629, Attorney Docket No. 2002P11413US01, filed Jul. 22, 2003 and entitled HERSCHEL-QUINCKE TUBE FOR VEHICLE APPLICATIONS which is hereby incorporated by reference in its entirety and which claims priority to U.S. Provisional Application Nos. 60/409,205 filed Sep. 9, 2002; 60/401,161 filed Aug. 5, 2002; and 60/397,708 filed Jul. 22, 2002.

### FIELD OF THE INVENTION

This invention relates to a Herschel-Quincke tube arrangement suitable for vehicle applications, and more particularly, to a Herschel-Quincke tube arrangement that provides noise cancellation at desired frequencies and which also fits within available vehicle space.

### BACKGROUND OF THE INVENTION

Vehicle air intake systems route air from the environment to the engine for use in the combustion process. Such systems include an air inlet, typically located at the front of the vehicle proximate to the radiator, for receiving outside air. Various passive or active noise cancellation systems may be connected to the air inlet and are located within the engine compartment. However, because of their size such systems may be difficult to package within the tight confines of modern engine compartments. Furthermore, increasing demands have been placed upon engine compartment space due to styling considerations, aerodynamics and additional vehicle systems components.

Passive noise cancellation systems such as quarter wave tubes and Helmholtz resonators are frequently used to generate pressure waves which serve to cancel noises that are generated during operation of a motor vehicle engine. Another type of passive noise cancellation system is a Herschel-Quincke (HQ) tube. HQ tubes may be configured to cancel noise over a broader frequency band than either quarter wave tubes or Helmholtz resonators. However, HQ tubes have not been effectively used in motor vehicle applications due to the long tube lengths that are required to attenuate noise within a desired range of frequencies. For example, the length of a conventional HQ tube configured to attenuate noise at 90 Hz is approximately 3.78 meters. By contrast, conventional HQ arrangements have attempted to tune frequencies between 1,000 to 3,000 Hz, thus requiring relatively short passages that are easier to fit within a motor vehicle.

Active noise cancellation (ANC) systems typically utilize a microphone and a relatively small speaker for generating an appropriate signal for canceling noise. In addition, ANC systems have relatively low power requirements. However, such systems are not suited for canceling noises generated by four cylinder engines. Four cylinder, four stroke engines typically generate high amplitude, low frequency engine noise (i.e. second and fourth order acoustic disturbances). As such, the speaker used in an ANC system is not large enough to cancel engine noise that is generated below approximately 2000 rpm (less than 66 Hz, second order). Further, excessive power (more than approximately 225 W) would be required to operate an amplifier in an ANC system when the engine is above approximately 3500 rpm.

Therefore, there is a need for an HQ tube arrangement which provides improved noise cancellation at desired frequencies and which also fits within limited vehicle space.

### SUMMARY OF THE INVENTION

A Herschel-Quincke tube arrangement for a vehicle is disclosed. The arrangement includes a first passageway having a fluid inlet and a fluid outlet and a second passageway located adjacent the first passageway. The second passageway is fluidly connected to the first passageway at first and second spaced apart junctions with the second passageway being divided by the junctions into first, second and third passages. The second passageway includes first and second terminal ends wherein portions of the first, second and third passageways are oriented in a substantially similar direction to that of the first passageway to form a substantially rectangular configuration.

These and other features of the present invention can be best understood from the following specification and drawings, the following of which is a brief description.

### BRIEF DESCRIPTION OF THE DRAWINGS

FIG. 1 is a schematic representation of an HQ tube arrangement.

FIG. 2 graphically depicts the actual transmission loss as compared to the theoretical transmission loss for the HQ tube arrangement.

FIG. 3 graphically depicts the analytical transmission loss as compared to the measured transmission loss for hard and flexible wall examples of the HQ tube arrangement.

FIG. 4A depicts the acoustic characteristics of a four cylinder, four stroke engine operating without the HQ tube arrangement.

FIG. 4B depicts the acoustic characteristics of a four cylinder, four stroke engine which utilizes the HQ tube arrangement.

FIG. 5 is a schematic view of a vehicle using the present invention.

FIG. 6A is an exploded perspective view of the HQ tube arrangement suitable for securing to a splash shield.

FIG. 6B is a cross-sectional view through the HQ tube arrangement taken along lines 6B-6B of FIG. 6A.

FIG. 7 is a schematic view of the HQ tube arrangement located within a fender.

FIG. 8 is a schematic view of the HQ tube arrangement secured to a vehicle engine compartment hood.

FIG. 9 the HQ tube arrangement used with a vehicle exhaust system.

FIG. 10 depicts a third embodiment of the HQ tube arrangement.

FIG. 11 depicts the third embodiment of the HQ tube arrangement removably attached to a washer bottle and/or power steering unit of the vehicle.

FIG. 12 depicts a fourth embodiment of the HQ tube arrangement.

FIG. 13 depicts a fifth embodiment of the HQ tube arrangement.

FIG. 14 depicts a sixth embodiment of the HQ tube arrangement schematically depicted within a front bumper of the vehicle.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of FIGS. 1-14.

An HQ tube arrangement 40 is shown schematically in FIG. 1. The arrangement includes a first passageway extending from an inlet 41 to an outlet 42. The outlet 42 may be connected directly or by tubes to a throttle or other noise cancellation systems. Similarly, the inlet 41 may be connected to other noise cancellation systems or it may directly receive the air from the environment or from an air cleaner module. The HQ tube arrangement 40 includes a second passageway 53 in fluid communication with the first passageway 52 at a first junction A and a second junction B. The junctions A and B separate the second passageway 53 into first 54, second 56, and third 58 passages. The first passageway is defined by the junctions A and B. The first passage terminates in a terminal end 64, and the third passage 58 terminates in a terminal end 66.

A desired noise cancellation frequency is selected for the noise cancellation system. For example, it may be desirable to cancel noise at 90 Hz. Because of the broad frequency of noise cancellation that an HQ tube provides, noise may be cancelled as low as 60 Hz and as high as 120 Hz for a target frequency of 90 Hz. Once the desired noise cancellation frequency has been selected, the lengths of the passages 54, 56, 58, and the first passageway 52 may be determined. The general equation below is used in determining the lengths:

$$λ = \frac{c}{f}$$

where
λ=wave length
c=Speed of sound
f=target frequency
Equation 1.
For a typical HQ tube arrangement, the length of the first passageway 52 is

$$\frac{λ}{2}$$

and the length of the second passage 56 is λ such that the noise cancellation wave within the second passage 56 is 180° out of phase with the pressure wave traveling in the first passageway 52. Typically, the lengths of the first 54 and third 58 passages are roughly

$$\frac{λ}{4}$$

and respectively terminate at ends 64 and 66 so they act as quarter wave tubes. It should be understood, however, that the lengths of the passages may be revised to fine tune the noise cancellation provided by the HQ tube arrangement 40.

The HQ tube arrangement 40 may be designed and optimized by determining an acoustic filter characteristic and computing a filter parameter a for any combination of tube lengths. The filter parameter a is given by the ratio of the average transmission loss over a specified frequency to the standard deviation of the transmission loss over the same specified frequency range.

$$α = \frac{\overline{TL}}{σ} \qquad Equation 2$$

The transmission loss at any frequency is defined as:

$$TL = 20 \times log ( \frac{{P}_{A}}{{P}_{S}} ) . \qquad Equation 3$$

The pressure ratio in Equation 3 is the ratio of the acoustic pressure entering junction A, P_{A} to the acoustic pressure transmitted past junction B, P_{B} and is given by:

$$\begin{matrix}\frac{{P}_{A}}{{P}_{B}} = \frac{\begin{matrix}1 - 2 {ⅇ}^{ⅈ ( {ϕ}_{1} + {ϕ}_{3} )} ( 1 + {ⅇ}^{ⅈ {ϕ}_{2}} ) ( 1 + {ⅇ}^{ⅈ {ϕ}_{4}} ) - \\ ( {ⅇ}^{ⅈ 2 {ϕ}_{1}} + {ⅇ}^{ⅈ 2 {ϕ}_{3}} ) {ⅇ}^{ⅈ ( {ϕ}_{2} + {ϕ}_{4} )} + \\ {ⅇ}^{ⅈ 2 ( {ϕ}_{1} + {ϕ}_{3} )} ( 1 + 2 {ⅇ}^{ⅈ {ϕ}_{4}} ) ( 1 + 2 {ⅇ}^{ⅈ {ϕ}_{2}} )\end{matrix}}{( {ⅇ}^{ⅈ {ϕ}_{1}} + {ⅇ}^{{ⅈϕ}_{3}} ) ( {ⅇ}^{ⅈ ( {ϕ}_{1} , {ϕ}_{3} )} - 1 ) ( {ⅇ}^{ⅈ {ϕ}_{2}} + 1 ) ( {ⅇ}^{ⅈ {ϕ}_{4}} + 1 )} \\ \text{where:} & Equation 4 \\ {ϕ}_{1} = \frac{2 π {l}_{1}}{λ} & Equation 5 \\ {ϕ}_{2} = \frac{4 π {l}_{2}}{λ} & Equation 6 \\ {ϕ}_{3} = \frac{2 π {l}_{3}}{λ} & Equation 7 \\ {ϕ}_{4} = \frac{4 π {l}_{4}}{λ} & Equation 8\end{matrix}$$

The tubes indicated by subscripts correspond to the circled numerals in FIG. 1.

The average transmission loss over the frequency range of Hz, which is the low end of the frequency range, to Hz, which is the high end of the frequency range is:

$$\overline{TL} = ( \frac{1}{BW} ) \times {\int }_{a}^{b} ( \frac{{P}_{A}}{{P}_{B}} ) ⅆ f ; BW = a - b \qquad Equation 9$$

and the standard deviation is given by:

$$σ = \sqrt{( \frac{1}{BW} ) \times {\int }_{a}^{b} {( \overline{TL} - TL )}^{2} ⅆ f} \qquad Equation 10$$

The lengths of the four tubes, indicated by the circled numerals 1-4 in FIG. 1, are independently varied over a specified range, and the transmission loss is calculated for each frequency at a specified range for each combination of tube lengths. The filter parameter a is then computed for each tube length combination. The combination of tube lengths which generates the maximum value for a is the desired configuration since this combination has the largest average transmission loss with the least ripple over the specified frequency range.

An additional constraint is imposed for packaging purposes. The more desirable tube combinations are those in which the tube length of the first passageway 52, indicated by the circled numeral 3, was the shortest of the four tubes. This constraint was desirable to minimize the flow restriction of the HQ tube arrangement 40 and to minimize the packaging length so that the device could be easily installed under the vehicle hood.

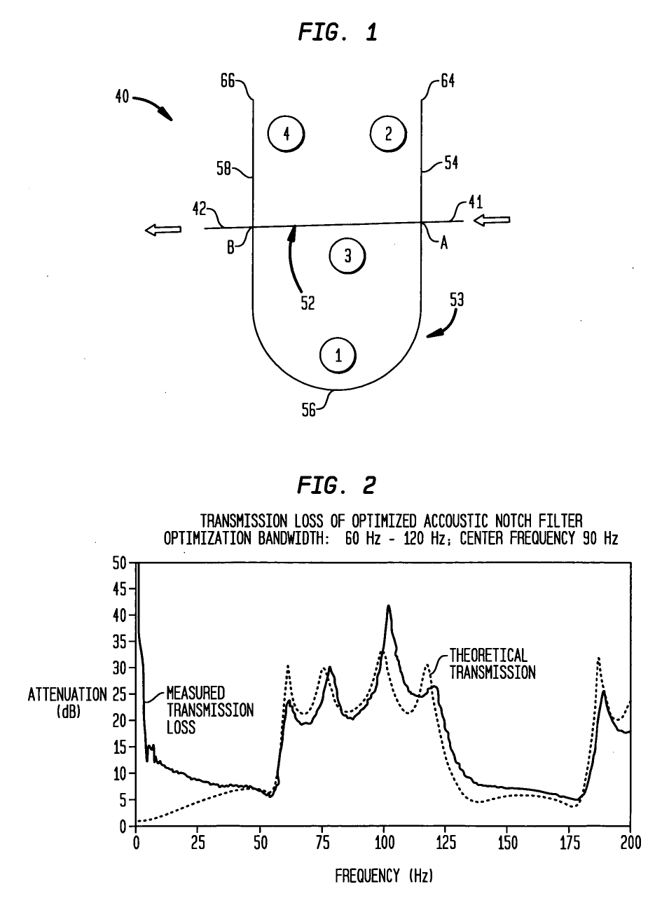

The computed transmission loss compared to the measured transmission loss for an optimized acoustic filter with a center frequency of 90 Hz and a bandwidth of 60 Hz is shown in FIG. 2. For this example filter design, the filter parameter α was 7.7, the tube length 1 was 2.78 meters, tube length 2 was 0.72 meters, tube length 3 was 0.58 meters, and tube length 4 was 1.3 meters. The inside tube diameter was 50 mm for both the first 52 and second 53 passageways. This particular arrangement had an average transmission loss of about 26 db, and as a result, will effectively attenuate the low frequency “boom” noise emanating either from the induction inlet or exhaust outlet. Also, the inventive design method provided “quarter wave tube” lengths that were unequal.

The analytical transmission loss compared to the measured transmission loss for hard and flexible wall examples of an HQ tube with a center frequency of 90 Hz and frequency range of 60 Hz (2/3 c/λ) to 120 Hz (4/3 c/λ) is shown in FIG. 3. For this example filter design, the inside tube diameter was 46 mm. As can be seen from FIG. 3, the attenuation is approximately 30 db in a useful range.

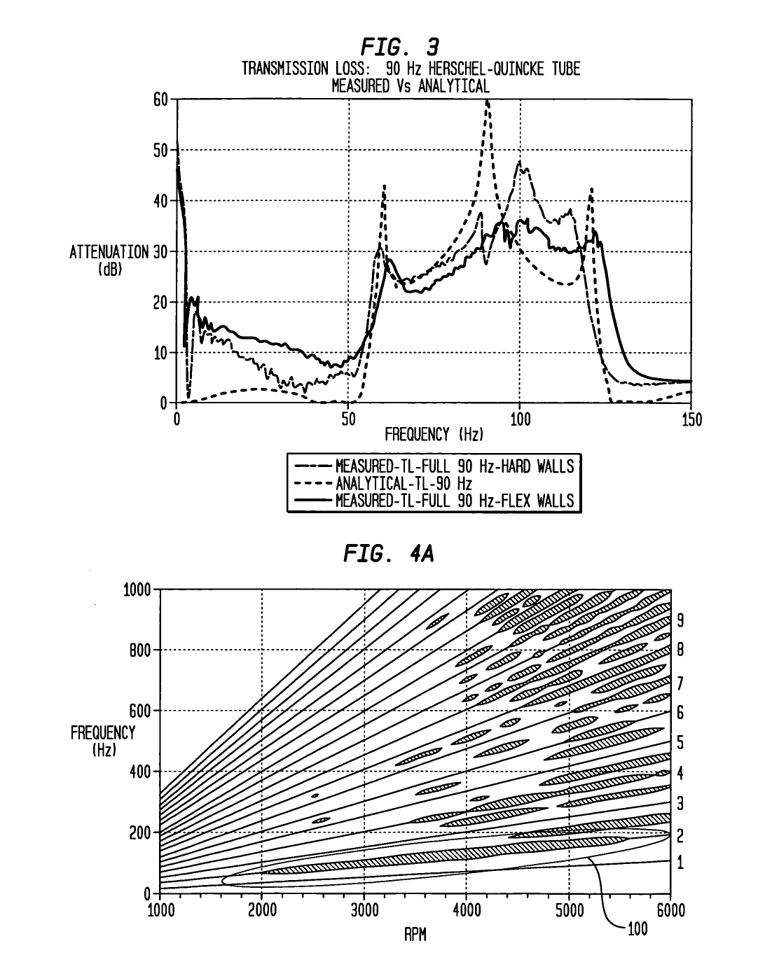

Referring to FIGS. 4A-4B, frequency vs. rpm (Campbell) diagrams are shown which illustrate differences in acoustic characteristics of a four cylinder, four stroke engine due the use of an HQ tube arrangement. In FIG. 4A, portion 100 illustrates a second order acoustic disturbance that is generated by a four cylinder engine operating without an HQ tube as previously described. In accordance with the present invention, an HQ tube for attenuating the second order acoustic disturbance may be installed in a duct either before or after the air cleaner of motor vehicle air intake system. Referring to FIG. 4B, the acoustic characteristics are shown of a four cylinder engine wherein an HQ tube is installed before the air cleaner. Referring to portion 100, it can be seen that the HQ tube substantially attenuates the second order acoustic disturbance.

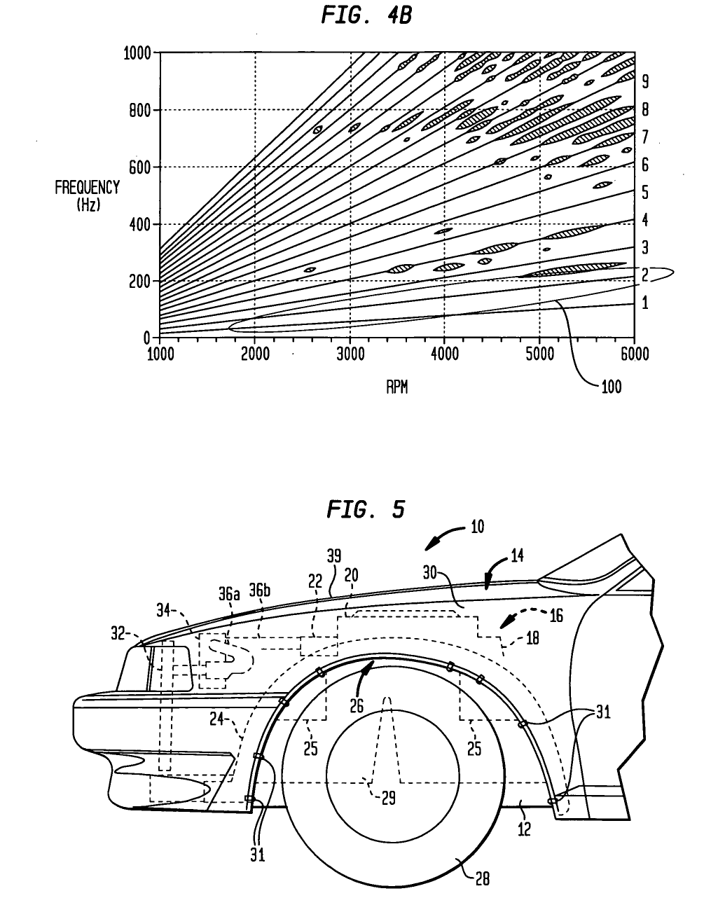

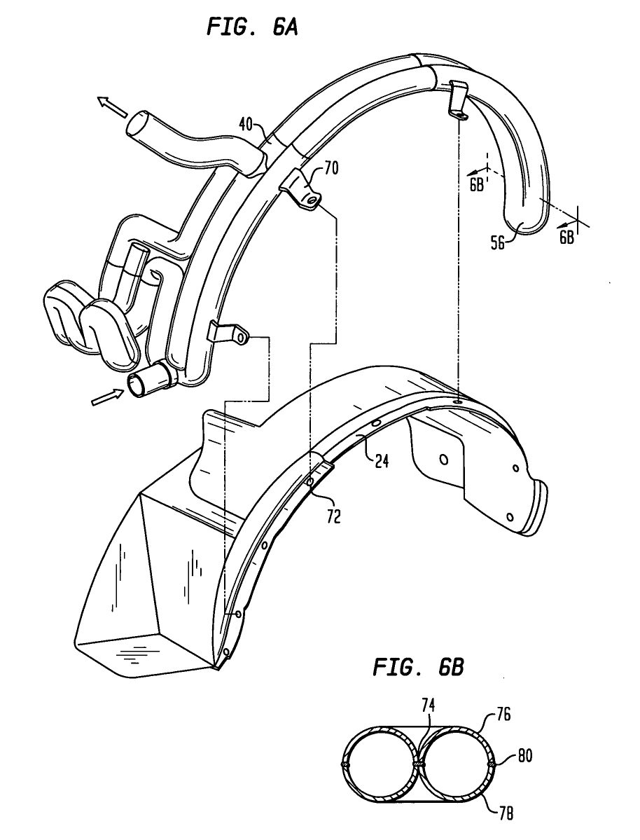

A vehicle 10 incorporating an example of the present invention is shown in FIG. 5. The vehicle 10 includes a frame 12 and a body 14 supported on the frame 12. The frame 12 and body 14 together define an engine compartment 16 at the forward end of the vehicle 10. However, it is to be understood that this invention may be utilized in a different location, for example, at the rear of the vehicle for rear engine configurations. The vehicle 10 includes an engine 18 having an intake manifold 20 and throttle 22 disposed within the engine compartment 16, as is well known in the art. The inventive HQ tube arrangement may be integrated with a fan shroud 32 as will be described in relation to FIG. 13. An air cleaner box 34 may be connected between the fan shroud 32 and the throttle 22 of the engine 18 by tubing 36a and 36b.

A splash shield 24 is arranged between the engine compartment 16 and a body fender 30 to define a wheel well 26. The splash shield 24 is C-shaped and arranged at least partially around a wheel 28 to prevent water and debris from entering the engine compartment 16. The splash shield 24 includes spaced apart downwardly extending flanges 25 that supports a rubber flap 29 arranged between the wheel 28 and the engine compartment 16, as is known in the art, to provide a further barrier to water and debris.

FIGS. 6A-9 depict other examples for locating an inventive HQ tube arrangement within the engine compartment of the vehicle. In FIG. 6A, a second embodiment of the HQ tube arrangement 40 is shown secured to the splash shield 24. The HQ tube arrangement 40 includes a flange or first connection 70 extending from the body of the HQ tube arrangement 40. The splash shield 24 has a second connection 72, which may be apertures, for securing the first connection 70 to the second connection 72 with fasteners. The splash shield 24 is secured to the fender 30 by fasteners 31 so that the splash shield 24 provides structural support for at least a portion of the fender 30.

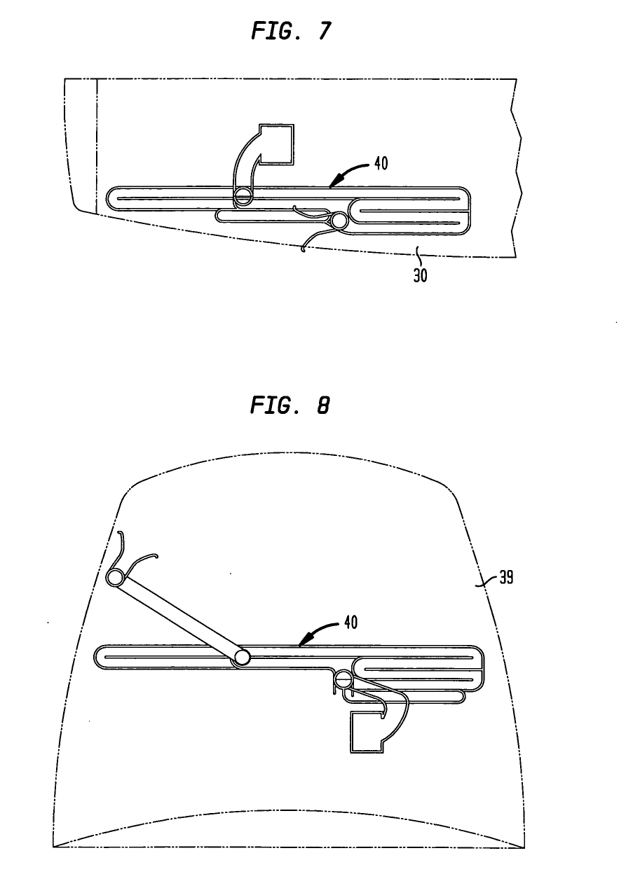

In another example, the HQ tube arrangement 40 is secured to and/or adjacent to the fender 30 (FIG. 7). An engine compartment hood 39 covers the top of the engine compartment. In still another example, an HQ tube arrangement 40 is secured to the hood 39 (FIG. 8).

While the present invention is described as an HQ tube arrangement, it is also to be understood that this invention may also include other noise cancellation systems such as quarter wave tubes or Helmholtz resonators connected to or integrated with the inventive HQ tube arrangement. In addition, the tubes in the HQ tube arrangement of the present invention may have a circular cross section or other cross section as desired.

Even with the tube lengths and diameters optimized using the inventive design process, the HQ tube arrangement 40 is still difficult to package within a vehicle. Accordingly, it is an aspect of this invention to arrange portions of the tubes adjacent to one another so that they double back along side one another and, more preferably, share a common wall. Referring to FIG. 6B, two tube portions are shown adjacent to one another sharing a common wall 74. The portions are formed by securing the first 76 and second 78 portions to one another by a weld bead 80 formed by vibration welding or by any other suitable securing means. The size of the HQ tube arrangement 40 may be dramatically reduced or minimized by having the tubes in the areas of the junctions A and B arranged adjacent to one another, as shown in the Figures. As can be seen in the Figures, the tubes are arranged in an adjoining relationship to one another whenever possible to minimize the size of the HQ tube arrangement 40.

The HQ tube arrangement 40 may be manufactured by forming the first 52 and second 53 passageways generally planar to one another with the convolutes preferably already formed so that portions of the tube are adjacent to one another. The HQ tube arrangement 40 may be manufactured using any suitable forming process, such as by injection molding, blow molding, vacuum forming, or thermo-forming plastics. The present invention may be constructed from aluminum or steel sheet metal formed by stamping and then welded. One suitable plastic may be a 20% talc filled polypropylene. The plastic pieces are welded together using any suitable process. The first 52 and second 53 passageways may then be bent into a nonplanar configuration into a shape suitable for securing to one of the components within the engine compartment, such as the splash shield 24, fender 30, or hood 39. The HQ tube arrangement 40 may be heated to facilitate bending the structure into a desired shape. The HQ tube arrangement 40 is then secured to the component.

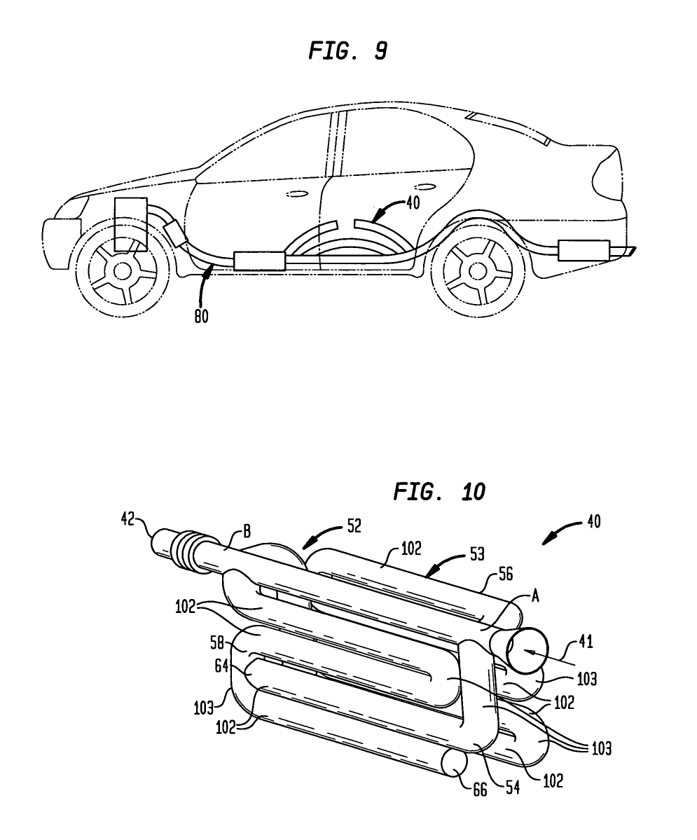

In another aspect of this invention, the HQ tube arrangement 40 may be used with the vehicle exhaust system 80, as shown in FIG. 9. The HQ tube arrangement 40 may be constructed from a material suitable for exhaust system application such as metal and connected with the exhaust system 80 using processes known to those of ordinary skill in the art.

Referring to FIG. 10, a third embodiment of the HQ tube arrangement 40 is shown. In this embodiment, the first 54 and third 58 passages are located adjacent the second passage 56. Portions of the first 54, second 56 and third 58 passages are bent so as to form a plurality of elongated sections 102 which are oriented in a substantially similar direction to that of the first passageway 52. The elongated sections 102 are connected by shorter transverse sections 103 to form a substantially rectangular or “briefcase” configuration. It is noted that the first 54, second 56 and third 58 passages may also be bent into other shapes to form the rectangular configuration. For example, the first 54, second 56 and third 58 passages may be sloped.

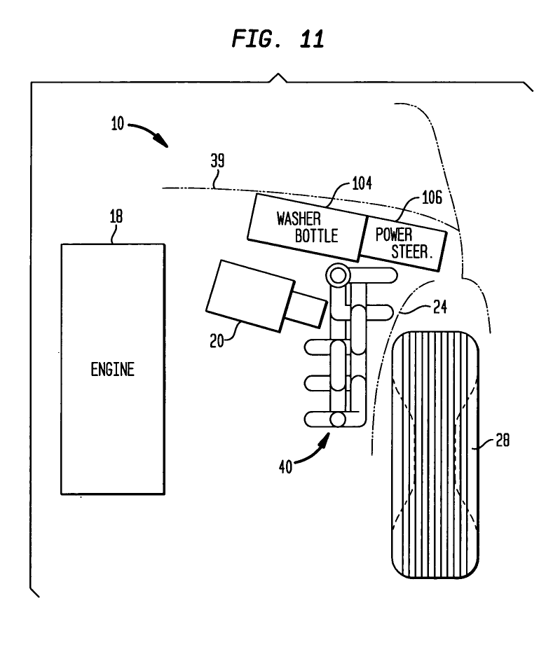

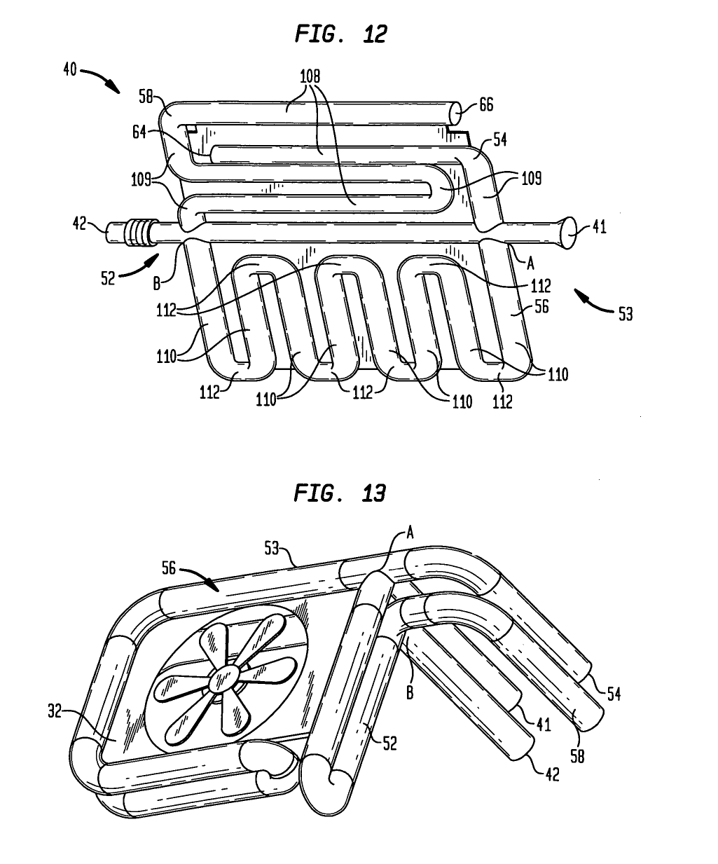

Referring to FIG. 11, a partial front view of the vehicle 10 under the hood 39 is schematically shown which depicts a possible location for the third embodiment of the HQ tube arrangement 40. It is noted that there are several available spaces within a motor vehicle wherein the tube arrangement 40 may be located. In this example, the HQ tube arrangement 40 is located in a space underneath a washer bottle 104 and power steering unit 106 located under the hood 39 and in between the manifold 20 and the splash shield 24. The washer bottle 104 and/or power steering unit 106 may include mounting tabs for removably securing the HQ tube arrangement 40. Alternatively, the washer bottle 104, power steering unit 106 and HQ tube arrangement 40 may be incorporated into a single structure.

Referring to FIG. 12, a fourth embodiment of the HQ tube arrangement 40 is shown. In this embodiment, the first 54, second 56 and third 58 passages are located in the same plane to form a substantially flat configuration. Portions of the first 54 and third 58 passages are bent to form a plurality of elongated sections 108 which are oriented in a substantially similar direction to that of the first passageway 52. The elongated sections 108 are connected by shorter transverse sections 109. Portions of second passage 56 are bent to form a plurality of elongated sections 110 which extend in a direction substantially transverse to that of the first passageway 52. The elongated sections 110 are connected by shorter lengthwise sections 112. It is noted that the first 54, second 56 and third 58 passages may also be bent into other shapes to form a substantially planar or flat configuration.

Referring to FIGS. 13, a fifth embodiment of the HQ tube arrangement 40 is shown positioned around fan shroud 32 which has a generally rectangular shape. In this embodiment, the second passageway 53 is bent and doubles back such that the second passageway 53 is located around three sides of the fan shroud 32. The first passageway 52 is formed in a U-shape and extends along the remaining side of the fan shroud 32. Inlet 41 and outlet 42 are depicted as inner branches of the HQ tube arrangement 40 whereas first 54 and second 58 passages are depicted as outer branches. Alternatively, these may be interchanged such that inlet 41 and outlet 42 are the outer branches and the first 54 and second 58 passages are the inner branches.

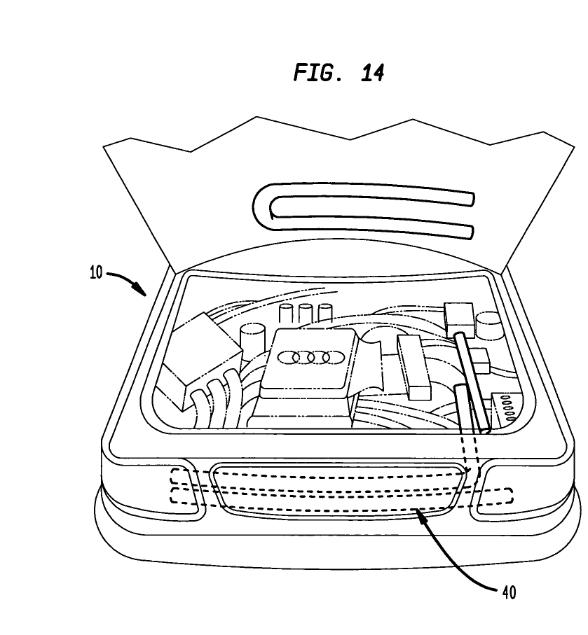

Referring to FIG. 14, a sixth embodiment of the HQ tube arrangement 40 is shown. In this embodiment, substantial portions of the HQ tube arrangement are located within a front bumper of a motor vehicle.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

1. A Herschel-Quincke tube arrangement for a vehicle comprising:
a first passageway having a fluid inlet and a fluid outlet; and
a second passageway located adjacent the first passageway, the second passageway being fluidly connected to the first passageway at first and second spaced apart junctions with the second passageway divided by the junctions into first, second and third passages, the second passageway including first and second terminal ends and wherein portions of the first, second and third passageways are oriented in a substantially similar direction to that of the first passageway to form a substantially rectangular configuration.

2. The arrangement according to claim 1, wherein the first and second passageways have the same diameter.

3. The arrangement according to claim 1, wherein the first and third passages are of unequal length.

4. The arrangement according to claim 1, wherein the arrangement is removably secured to a component under a hood of a vehicle.

5. The arrangement according to claim 1, wherein the component is washer bottle and power steering reservoir.

6. The arrangement according to claim 5, wherein the arrangement is incorporated with the washer bottle and power steering reservoir into a single structure.

7. The arrangement according to claim 1, wherein said arrangement is constructed from plastic.

8. The arrangement according to claim 1, wherein said arrangement is located before an air intake system of the vehicle.

9. The arrangement according to claim 1, wherein said arrangement is located after an air intake system of said vehicle.

10. A Herschel-Quincke tube arrangement for a vehicle comprising:
a first passageway having a fluid inlet and a fluid outlet; and
a second passageway located in a same plane as the first passageway, the second passageway being fluidly connected to the first passageway at first and second spaced apart junctions with the second passageway divided by the junctions into first, second and third passages, the second passageway including first and second terminal ends and wherein portions of the first and third passageways are oriented in a substantially similar direction to that of the first passageway and portions of the second passage are oriented in a direction substantially transverse to that of the first passageway to form a substantially flat configuration.

11. The arrangement according to claim 10, wherein the first and second passageways have the same diameter.

12. The arrangement according to claim 10, wherein the first and third passages are of unequal length.

13. The arrangement according to claim 10, wherein said arrangement is constructed from plastic.

14. The arrangement according to claim 10, wherein said arrangement is located before an air intake system of the vehicle.

15. The arrangement according to claim 10, wherein said arrangement is located after an air intake system of said vehicle.

16. A Herschel-Quincke tube arrangement located around a vehicle fan shroud, comprising:
a first passageway having a fluid inlet and a fluid outlet, the first passageway having U-shape and extending down a side of said shroud; and
a second passageway located adjacent the first passageway, the second passageway being fluidly connected to the first passageway at first and second spaced apart junctions with the second passageway divided by the junctions into first, second and third passages, the second passageway being bent and doubling back such that the second passageway is located around remaining sides of said shroud.

17. The arrangement according to claim 16, wherein the first and second passageways have the same diameter.

18. The arrangement according to claim 16, wherein the first and third passages are of unequal length.

19. The arrangement according to claim 16, wherein said arrangement is constructed from plastic.

20. The arrangement according to claim 16, wherein said arrangement is located before an air intake system of the vehicle.

21. The arrangement according to claim 16, wherein said arrangement is located after an air intake system of said vehicle.
